(19) United States
(12) Patent Application Publication
(10) Pub. No.: US 2009/0300514 A1
(43) Pub. Date: Dec. 3, 2009

(54) SYSTEM FOR EFFECTIVE MEETING INVITEE RESPONSE STATUS

(75) Inventors: Frank Lawrence Jania, Chapel Hill, NC (US); John Morgan Lance, Littleton, MA (US)

Correspondence Address: Locke Lord Bissell & Liddell LLP;Attn: IP Docketing, Three World Financial Center, New York, NY, 10281-2101, US

(73) Assignee: IBM CORPORATION, Armonk, NY (US)

(21) Appl. No.: 12/127,485

(22) Filed: May 27, 2008

(51) Int. Cl. G06F 3/048

(52) U.S. Cl. 715/751

(57) ABSTRACT

A system for visually representing an event as part of a larger schedule (e.g., calendar). The representation of the particular event may include an indicator configured to display invitee status. Functionality may also be configured to provide additional information, for example, by user interaction. In at least one instance, a user may move a mouse over the invitee status indicator to trigger a pop-up box with the additional information. Additional functionality, that may be implemented alone or in conjunction with the above exemplary embodiments of the present invention, may include the automatic execution of an activity in view of a threshold condition related to the event. For example, when an event is created, a threshold condition pertaining to one or more characteristics of the event and/or an activity may be configured. When the threshold condition is met and/or exceeded, the configured activity may be triggered.

### BACKGROUND

1. Field of Invention

Various embodiments of the present invention relate to automated event planning, and more specifically, to a system that may be configured to visually represent, and in some cases to act based upon, the status of invitees to an event via an electronic event planning system.

2. Background

The fast pace of life in modern society may necessitate the inclusion of various activities into a daily schedule. As some of these tasks may occur at the same time, a schedule is often relied upon for both professional and personal use in order to avoid conflicts. Traditional schedules may include, for example, paper calendars used to document meetings, appointments, events, etc. However, as with many “traditional” practices, the paper-based solutions have been replaced by computerized devices that may be used to quickly and efficiently manage a schedule.

Computerized scheduling may not only facilitate the management of a particular user's schedule, but may also be used to coordinate the schedules of a plurality of user. For example, a user may create an event (e.g., a meeting) utilizing a computerized scheduling system that supports both the reservation of resources that may be needed for the event (e.g., conference room, overhead or video projectors, computers, note-taking materials, textual meeting materials, court reporter/secretary, food, etc.), and an automated process by which others are invited to the event. For example, a computerized scheduling system may allow a user to add invitees to the event, such as by selecting them from a general user database. The invitees may then receive an electronic meeting invitation, to which an electronic response may be sent regarding attendance.

As a matter of course, some invitees may be unable to attend an event (e.g., due to schedule conflicts). However, these invitees may not decline in a timely manner, or may decline just before the event due to unforeseen circumstances. These situations may be problematic for an event planner, for example, when a minimum number of attendees is required to proceed with the event, if a certain invitee is required to attend to proceed with the event, if reserved resources will be wasted. Existing systems are not able to expeditiously apprise users of event invitees that have accepted, declined, not responded, etc., or of event cancellation/alteration decision criteria.

### SUMMARY

Various embodiments of the present invention are directed to an event planning system configured to visually represent, and in some cases to act based upon, invitee status. A user may create an event in a computerized scheduling system, and may proceed to invite other users to attend the event (“invitees”). The invitees may be notified of the meeting via electronic communication, and may further respond to the invitation in a similar manner. The “status” of the user, therefore, may include whether the invitee has responded positively or negatively to the invitation, not responded at all, has responded with a comment or answer to a question, etc.

In at least one embodiment of the present invention, invitee status may be displayed to the user that created the event (e.g., the event planner) in a diagrammatic manner. For example, a particular event may be visually represented in a larger schedule (e.g., calendar). The representation of the particular event may include an indicator configured to display invitee status. In particular, the event planner may be able to determine an exact or approximate number of invitees in one or more response categories (e.g., accepted the invitation, declined the invitation, has not yet responded, has responded with comments, etc.) Functionality may also be configured to provide additional information, for example, by user interaction. In at least one instance, a user may move a mouse over the invitee status indicator to trigger a pop-up box with the additional information. This additional information may include the exact number of invitees in each response category and other information pertaining to event invitee response status.

Additional functionality, that may be implemented alone or in conjunction with the above exemplary embodiments of the present invention, may include the automatic execution of an activity in view of a threshold condition related to the event. For example, when an event is created, a threshold condition pertaining to one or more characteristics of the event may be configured, possibly in conjunction with an activity. When the threshold condition is met and/or exceeded, the configured activity may be triggered. For example, a notification may be sent to the user regarding the threshold condition, the status of the event, invitees, resource, etc. may be altered, etc. Further, the triggered activity may be configured to affect some or all of the invitees in one or more response classes. For example, all invitees may be notified that the event is going to be canceled when a certain number or percentage of invitees have declined the event.

### DESCRIPTION OF DRAWINGS

The invention will be further understood from the following detailed description of various exemplary embodiments, taken in conjunction with appended drawings, in which:

FIG. 1 discloses an exemplary computer and communication system with which various embodiments of the present invention may be implemented.

FIG. 2 discloses a schedule including an exemplary event representation in accordance with at least one embodiment of the present invention.

FIG. 3 discloses additional functionality that may be configured in the event representation of FIG. 2 in accordance with at least one embodiment of the present invention.

FIG. 4 discloses a flowchart of an exemplary process in accordance with at least one embodiment of the present invention.

### DESCRIPTION OF EXEMPLARY EMBODIMENTS

While the present invention has been described herein in terms of a multitude of exemplary embodiments, various changes or alterations can be made therein without departing from the spirit and scope of the present invention, as set forth in the appended claims.

I. General System with which Embodiments of the Present Invention May be Implemented

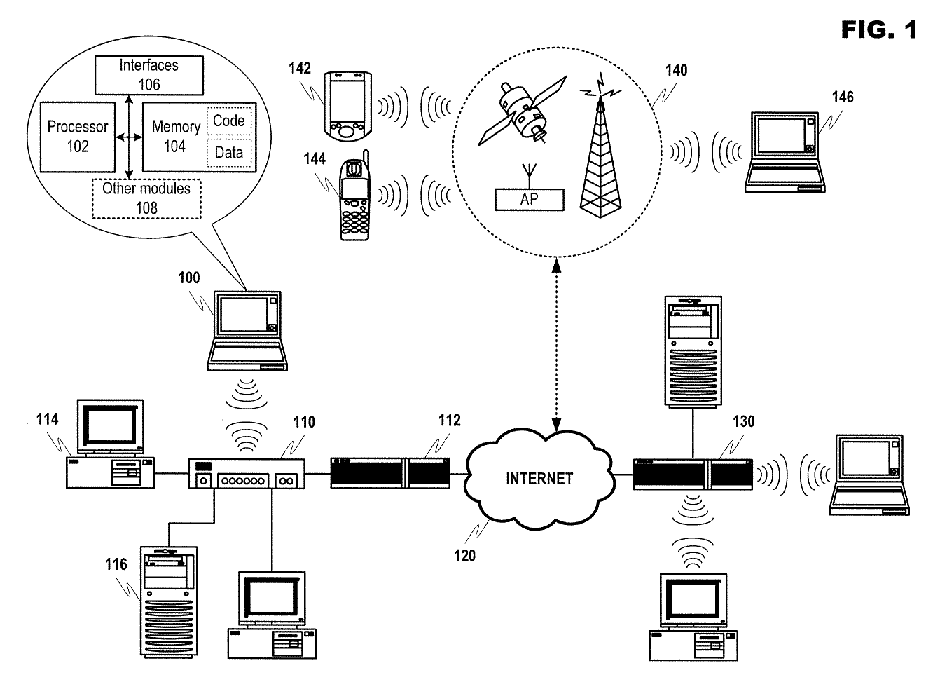

An example of a system that is usable for implementing the various embodiments of the present invention is disclosed in FIG. 1. This system comprises elements that may be included in, or omitted from, a configuration depending, for example, on the requirements of a particular application, and therefore, is not intended to limit present invention in any manner.

Computing device 100 may be, for example, a laptop computer. Elements that represent basic exemplary components comprising functional elements in computing device 100 are disclosed at 102-108. Processor 102 may include one or more devices configured to execute instructions, wherein a group of instructions may be constituted, for example, as program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 100 may provide wired and/or wireless support to devices such as computer 114 and server 116. Hub 100 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this exemplary configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Examples of Event Representation

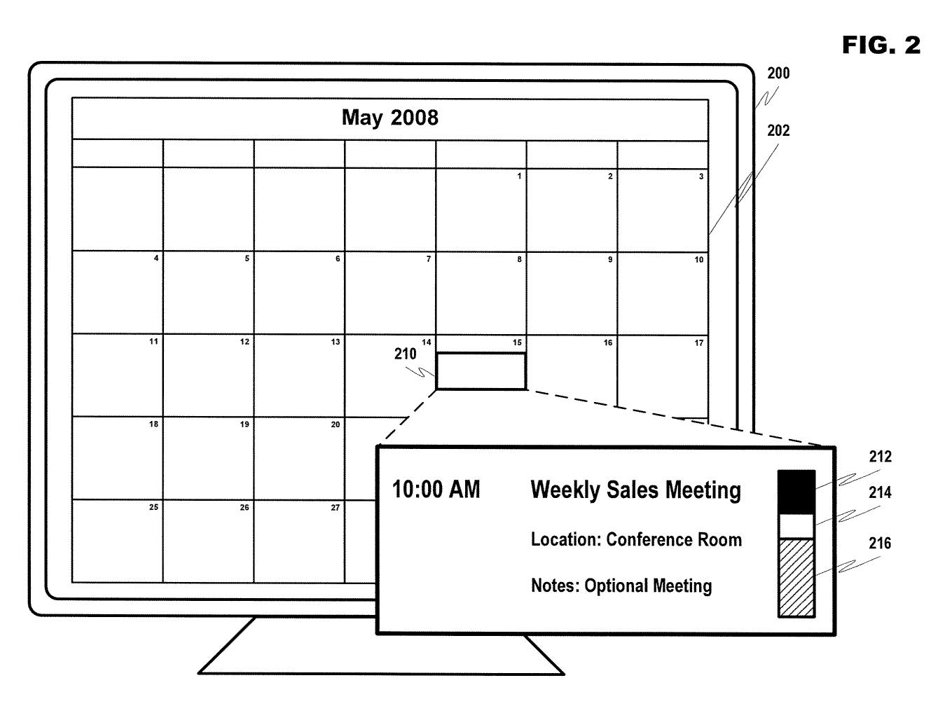

FIG. 2 discloses an exemplary configuration in accordance with at least one embodiment of the present invention. For example, a computer monitor 200 coupled to an apparatus including some or all of the elements of computing device 100 may display a schedule 202. Schedule 202 has been disclosed in the form of a calendar, but may also take other forms such as the emulation of a daily planner page, etc. Event representation 210 may be displayed in schedule 202, and may represent an event scheduled by an event planner (e.g., a user of the apparatus that configured the event). Examples of events that may be created in accordance with various embodiments of the present invention include meetings, appointments, conventions, etc.

Exemplary event representation 210 is directed to a sales meeting for the sake of explanation in the disclosure. This visual representation of the event may include information such as the name and time of the event, and may optionally include additional information such as the location of the event or other comments that may be pertinent to invitees when considering attendance. In this example the sales meeting is being held at 10:00 AM in the conference room, and this meeting is optional. Other information that may be included may, for example, ask a question to which an answer is remitted in the event reply, discuss an event agenda, list materials that are necessary for the event, discuss other events related to the main event (e.g., mails), etc.

Event representation 210 may further include an indicator (212-214 in FIG. 2). The indicator may utilize such characteristics as size, color, location, activity (e.g., flashing or movement) to indicate status information pertaining to meeting invitees. For example, a bar graph is shown in event representation 210 that includes three different colored sections. Black section 212 may, for example, indicate the relative number of invitees that declined the event. Further white section 214 may represent the relative number of people are attending the event, while grey section 216 may indicate the relative number of people that have not yet responded.

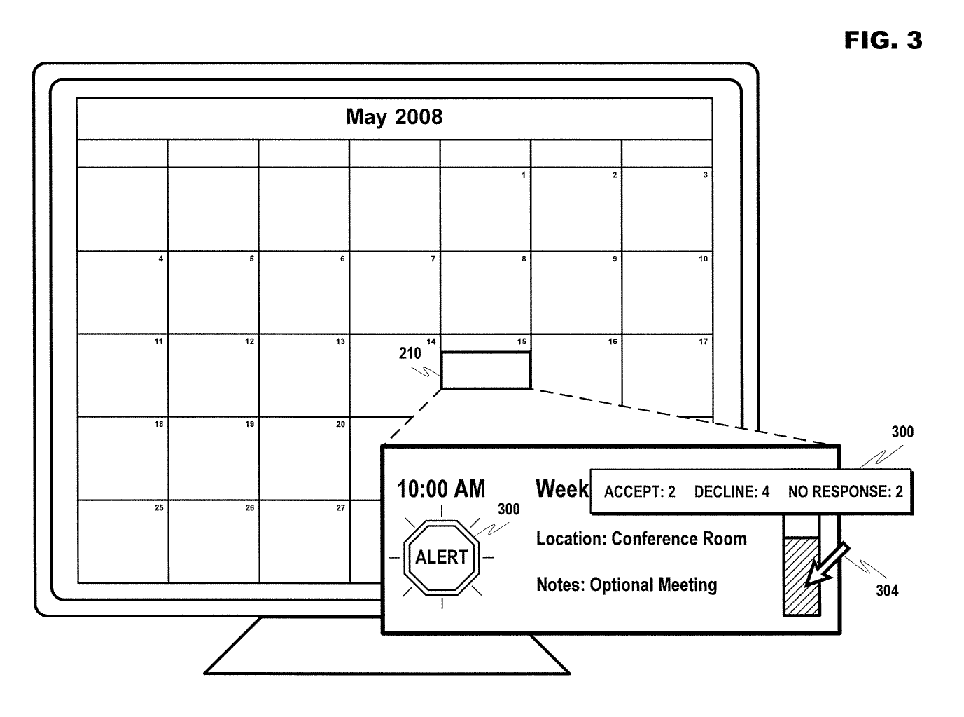

Utilizing the exemplary event representation of FIG. 2, a user (e.g., an event planner) may determine the current status of the event with respect to the invitees by simply viewing the event. This may save time by allowing the user to avoid having to navigate through various menus or screens in order to obtain to this information. Additional functionality may be also be incorporated in event representation 210 that may, example, readily provide additional event-related information to the user (e.g., an event planner), or may automatically notify or alert a user to a particular situation. For example, additional information may be provided to the user through the use of a triggering event. In the disclosed example, a user may “mouse-over” the invitee status indicator (e.g., the user may move a computer input device so that arrow pointer 304 is positioned over the invitee status indicator with or without clicking). This event may, in turn, trigger the display of pop-up box 200. Pop-up box 300 may provide additional information such as the actual number of invitees in each response category (as disclosed in FIG. 3), answers to questions included in the event invitation, comments from invitees regarding the meeting, etc.

Further, FIG. 3 also includes a representation of alert indicator 300. An event planner may configure one or both of a threshold value and an action to execute automatically take when the threshold value is met and/or exceeded. For example, an event may be configured automatically canceled when some or all of the invitees reply negatively or don't reply at all. In at least one embodiment of the present invention, cancellation may further include automatically notifying the meeting planner and/or invitees that a threshold condition has been satisfied, that the event has been canceled due to lack of participation, rescheduled, etc. Other examples of actions that may include, but are not limited to, sending a notification to all accepting invitees when a particular invitee has canceled (e.g., a scheduled speaker), releasing reserved resources after a predetermined number of invitees that have canceled, automatically confirming reserved resources when an accepting invitee threshold has been crossed, moving the event to an alternate date when a threshold number of invitees have declined or not responded by a certain date, etc.

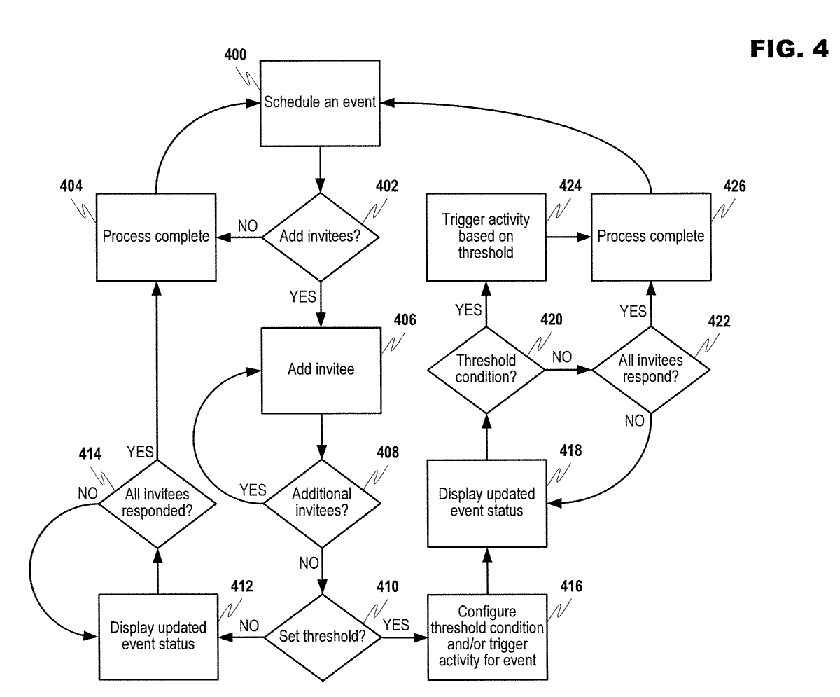

An exemplary process, in accordance with at least one embodiment of the present invention, is disclosed in FIG. 4. Some or all of these process steps may be performed, for example, by processor 102 executing a computer readable program code stored in memory 104 (e.g., as shown in FIG. 1). This program code may be embodied in fixed or removable memory comprising, for example, electronic (e.g., RAM, ROM, Flash, EPROM), magnetic (e.g., floppy or hard drive) and/or optical (e.g., CD, DVD) mediums. In step 400 an event may be scheduled. If the event will not include invitees (e.g., a personal appointment), then a determination may be made in step 402 that the process is completed (step 404), which may then be followed by returning to step 400 in preparation for scheduling another event. Alternatively, if one or more parties will be invited to the event, then step 402 may proceed to step 406 where an invitee is added. Adding an invitee may include selecting a user or group of users from a user database (e.g., by dragging, double clicking, etc.), manually inputting invitee information, etc. Adding invitees may continue in step 408 until a determination is made that all invitees have been added.

The exemplary process of FIG. 4 may continue in step 410 where a determination is made as to whether a threshold condition should be set. If no threshold condition is needed or desired, then in step 412 an event representation may be displayed including a meeting status indicator. The event representation (and meeting status indicator) may continue to be updated with current invitee response information in step 414 until all invitees have responded for the event. The process may then be completed in step 404 and restart for the next event in step 400.

If a threshold condition is needed or desired in step 410, then in step 416 a threshold condition and/or trigger activity may be configured for the event. A threshold condition may pertain to, for example, a number of users in one or more categories that reply to the event in a certain manner (e.g., decline the event). Further, an activity may be configured to trigger when the threshold condition is met or exceeded. This triggered activity may, for example, include notifying the event planner and/or event invitees of the invitee response status, canceling the event, rescheduling the event, confirming or releasing resources reserved for the event, etc. The process may then continue in step 418 where the event representation may be displayed including some sort of invitee status indicator. However, in this particular mode the process may first inquire in step 420 as to whether the threshold condition has been satisfied before determining whether all invitees have responded in step 422. If the threshold condition has been met, then in step 424 the activity associated with the particular threshold condition may be triggered, and the process may complete in step 426. Otherwise, when it is determined that all invitees have responded in step 422, then the process may similarly complete in step 426, followed by returning to step 400 to await the configuration of the next event.

It is further important to note that, in accordance with various embodiments of the present invention, that more than one threshold condition may be configured for any event. For example, threshold conditions related to meeting cancellation and/or notification procedures, as well as events pertaining to confirming and/or releasing reserved resources in view of the invitee status. Further, various embodiments of the present invention are not limited only to the specific schedule, event representation or invitee status indicator configurations disclosed herein, and may utilize other visual representation and/or indicators such as pie graphs, stoplight indicators, flowcharts, progress meters, gauge indicators, etc.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

1. A computer program product comprising computer executable instructions embodied on a computer readable medium, the computer executable instructions being configured to cause a computing apparatus to perform activities, comprising:
creating at least one scheduled event in a computerized scheduling system, the scheduled event having one or more invited participants who can respond to the event invitation via electronic communication;
displaying a schedule including a representation of the at least one scheduled event, the scheduled event representation having an attendance indicator showing the amount of invited participants who have accepted the invitation to the scheduled event, declined the invitation to the scheduled event or have not yet responded to the invitation;
determining whether a predetermined threshold condition corresponding to the scheduled event has been configured in the computerized scheduling system, and if the predetermined threshold condition has been configured, executing an action when the predetermined threshold condition has been met, the action including at least one of notifying the scheduled event creator that the threshold condition has been met, sending an inquiry to the scheduled event creator as to whether the event should be rescheduled, or canceling the scheduled event and notifying some or all of the invited participants.
